(19) United States
(12) Patent Application Publication
(10) Pub. No.: US 2026/0087341 A1
(43) Pub. Date: Mar. 26, 2026

(54) OPTICAL RESERVOIR COMPUTER

(71) Applicant: Microsoft Technology Licensing, LLC, Redmond, WA (US)

(72) Inventor: Tuomo von Lerber, Helsinki (FI)

(21) Appl. No.: 18/893,627

(22) Filed: Sep. 23, 2024

(51) Int. Cl. G06N 3/067; G02B 3/00; G02B 5/02

(52) U.S. Cl. CPC G06N 3/067; G02B 3/0056; G02B 5/02

(57) ABSTRACT

A reservoir computing system comprises an input system configured to generate an input signal, an optical reservoir configured to receive the input signal from the input system, and an output system configured to generate an output signal based on light received from the optical reservoir. The optical reservoir comprises a plurality of reservoir lasers configured for injection-locked operation and a reservoir randomization element configured to randomly distribute light output by the plurality of reservoir lasers among the plurality of reservoir lasers to contribute to injection locking of the plurality of reservoir lasers.

### BACKGROUND

Artificial intelligence (AI) solutions have been developed and applied to different problems and tasks in various industries. Many AI solutions are implemented using machine learning models that are trained on large datasets to recognize patterns, make predictions, provide classifications/labels, etc. These models can take on various forms and architectures, such as neural networks, decision trees, support vector machines, and/or others. Common neural network architectures include convolutional neural networks (CNNs), recurrent neural networks (RNNs), long short-term memory (LSTM) networks, and transformer models. Such models are often deployed on cloud platforms, servers, or specialized hardware.

Hardware acceleration refers to the use of specialized hardware components to perform specific computational tasks more efficiently than general-purpose central processing units (CPUs). Specialized hardware components can be designed to handle the parallel processing and high computational demands of machine learning tasks. Hardware acceleration can significantly speed up the training and/or inference of machine learning models, enabling faster and more efficient AI solutions.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a conceptual representation of components of an example optical reservoir for a reservoir computing system.

FIG. 2 illustrates a schematic diagram of an example optical reservoir for a reservoir computing system.

FIG. 3 illustrates a conceptual representation of components of an example reservoir computing system including an optical reservoir.

FIG. 4 illustrates a schematic diagram of an example input system for a reservoir computing system.

FIG. 5 illustrates example components of an example system that may include or be used to implement one or more disclosed embodiments.

### DETAILED DESCRIPTION

Disclosed embodiments are generally directed to an optical reservoir computer framework.

As indicated above, AI solutions have received significant attention and can be implemented using various types of hardware. Reservoir computers are a type of neural network or machine learning model architecture and are often utilized for time-series prediction, speech recognition, and dynamic system modeling. Reservoir computing typically involves transforming input data into a high-dimensional space using a fixed, randomly initialized neural network (i.e., the reservoir) while only training a simple readout layer to map the reservoir's dynamic states to the desired output. Reservoir computing frameworks can significantly reduce the computational cost associated with training traditional recurrent neural networks, as only the readout weights are updated during the learning process, while the reservoir weights remain unchanged.

In conventional reservoir computers, the reservoir itself is implemented as a randomly connected recurrent neural network, where each neuron's state is influenced by its past states and inputs. This enables the reservoir to capture and retain information over time, providing a rich set of features that can be used for predicting future states of a system or recognizing patterns in sequential data. The randomness and fixed nature of the reservoir weights create a nonlinear mapping of the input space, allowing for effective representation of complex temporal dependencies without requiring extensive training.

CPUs and graphics processing units (GPUs) have been developed for specific purposes (e.g., general-purpose and graphics computing, respectively) and are not tailored to neural network inference or training operations, which are often computationally expensive. Neural processing units (NPUs) have been specifically developed to compute feed-forward neural networks with high speed and efficiency (though training remains a challenge). NPUs are typically implemented as electronic devices that deal with real-valued signals, giving them a limited capacity of matrix-vector multiplication and, therefore, limited connectivity between neurons. NPUs are also less efficient at computing network architectures with bidirectional or recurrent connections, such as reservoir computers. Accordingly, CPUs, GPUs, NPUs, and other existing hardware solutions are not well-suited for accelerating reservoir computers.

The disclosed subject matter is directed to an optical neural network design that uses injection-locked lasers as neurons and light as an information carrier. Under an injection-locked laser framework, the output of one laser (sometimes referred to as a master laser) is used to control and/or synchronize the emission of another laser (sometimes referred to as a slave laser). Injection-locked operation can involve injecting a small amount of light from the master laser into the slave laser's cavity. If the frequency of the injected light is sufficiently close to the natural frequency of the slave laser, the slave laser's emission becomes locked to the frequency and phase of the master laser. As a result, the slave laser emits light with the same frequency, phase, and, often, polarization as the master laser, even though the power of the injected light is typically much lower than the power output of the slave laser. Injection locking of lasers can be achieved because the injected light from the master laser modifies the oscillation conditions within the slave laser's cavity. The slave laser's gain medium and cavity are forced to oscillate at the injected frequency, thereby overriding the laser's natural tendency to oscillate at its own independent frequency. This locked state can be maintained over a specific range of frequencies known as the locking range, which can depend on factors such as the power of the injected signal, the detuning between the master and slave frequencies, and the intrinsic properties of the lasers (e.g., linewidths, coupling efficiency, etc.).

At least some disclosed embodiments comprise a reservoir computer implementation that naturally provides a reservoir of injection-locked lasers with random weighted connections that are recurrent and recursive (though the weighted connections can be non-random if desired). In one example, the reservoir includes lasers configured for injection-locked operation and a randomization element that randomly distributes/directs the light emitted by the lasers toward/among the various lasers, which contributes to injection locking of the lasers. The lasers can be arranged to form a laser array, and the randomization element can be implemented as a randomly diffuse screen that diffusely reflects laser light back toward the laser array and diffusely transmits light toward an output system.

The lasers of the reservoir (“reservoir lasers”) can be further injection-locked via input light from an input system, which may itself include input lasers and a randomization feature to distribute the input light from the input lasers among the reservoir lasers. The input lasers can be controlled/modulated to encode input data for inference and/or training of the reservoir computer. The output system can receive light from the reservoir and can be configured to generate an output signal based on the received light (e.g., via a photodiode array). In one example, the output system includes a spatial light modulator (e.g., liquid crystals, polarizing filter, or others), which can be controlled based on weights obtained via model training techniques.

An optical reservoir computer as disclosed herein can facilitate various benefits relative to conventional reservoir computers with reservoirs that rely on electronic processing components such as GPUs, NPUs, etc. For instance, an optical reservoir as disclosed herein can provide bidirectionality and massive parallelism in the connections between neurons (e.g., lasers acting as neurons). The neurons of the optical reservoir can be vastly more connected than conventional NPU-computed networks, which can provide highly accelerated inference times. Furthermore, in some implementations, an optical reservoir computer as disclosed herein is not restricted to real-valued neural network operation, but rather processes complex-valued signals or 2-dimensional complex-valued signals within the reservoir, increasing its dimensionality (which can achieve desired performance with fewer neurons). An optical reservoir computer may be well-adapted for applications where the data is optical, such as in data centers. Additionally, lasers can provide convenient and strong nonlinearity, which is a basic characteristic for neural networks.

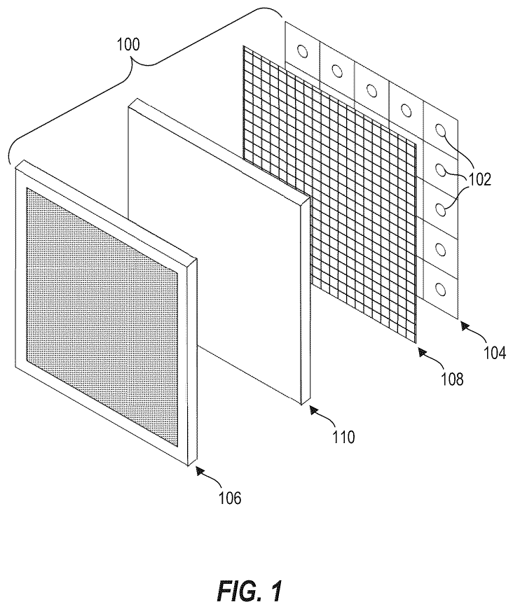

Having just described some of the various high-level features and benefits associated with the disclosed embodiments, attention will now be directed to FIGS. 1 through 5. These Figures illustrate various conceptual representations, architectures, methods, and supporting illustrations related to the disclosed embodiments.

### Optical Reservoir Computer

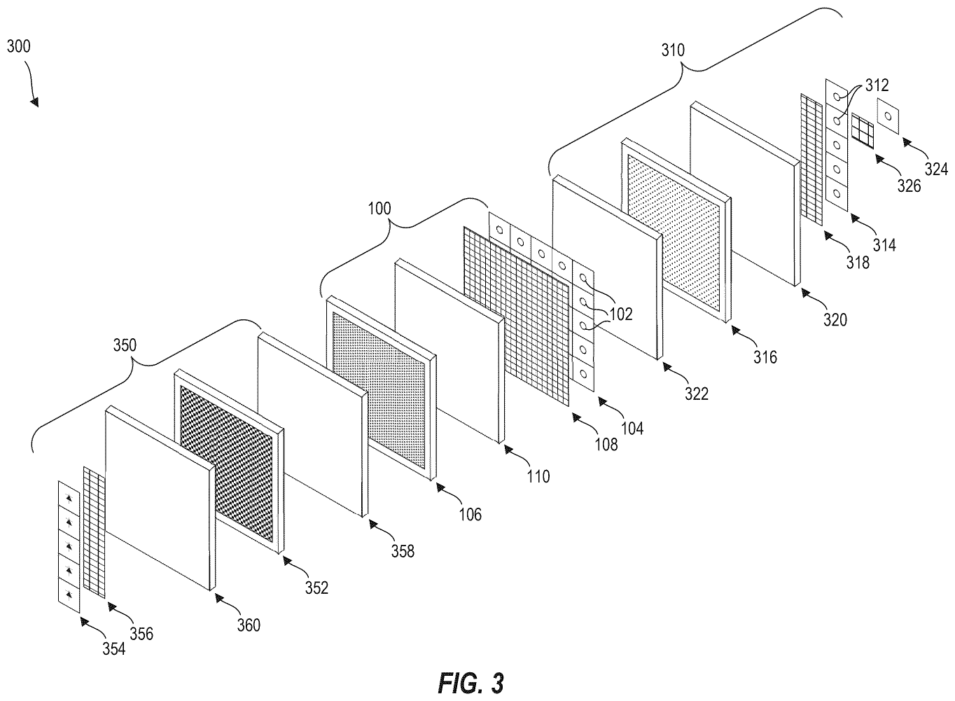

FIG. 1 illustrates a conceptual representation of components of an example optical reservoir 100 for a reservoir computing system. The optical reservoir 100 can be configured to receive an input signal from an input system, an example of which will be described in more detail below with reference to FIG. 3. The input signal can take on various forms, such as input light, control signals for controlling pumping/modulation of the lasers of the optical reservoir 100, etc. In the example shown in FIG. 1, the optical reservoir 100 includes reservoir lasers 102 that are arranged in an array, forming a reservoir laser array 104. The reservoir lasers 102 can comprise injection-lockable lasers (i.e., configured for injection-locked operation), each of which can act as a node or neuron for the optical reservoir 100. The reservoir lasers 102 can be coherent over a time scale of interest, can be configured to emit light with substantially the same wavelength (e.g., within a few nanometers), and can be configured to be pumped with a consistent polarization state (e.g., linear polarization).

FIG. 1 also illustrates the optical reservoir 100 as including a reservoir randomization element 106, which is positioned to receive light generated by the reservoir lasers 102. The reservoir randomization element 106 is adapted to randomly distribute the received light among the reservoir lasers 102, such as by scattering or diffusely reflecting the light back toward the reservoir lasers 102. The reservoir randomization element 106 can be implemented as a diffuse screen (e.g., a randomly diffuse screen) that is at least partially diffusely reflective. The reservoir randomization element 106 can redirect (e.g., diffusely reflect) the light received from the reservoir lasers 102 back toward the reservoir lasers 102 in a manner that randomizes the reflection angle, spatial distribution, time delay, amplitude, phase, and/or polarization of the light.

The randomization characteristics (e.g., diffuse reflection characteristics) of the reservoir randomization element 106 can be fixed overtime (e.g., similar to the fixed randomized connections between neurons of conventional electronics-based reservoir computers). In some instances, the randomization characteristics of the reservoir randomization element 106 are specifically tailored to mitigate lost light, such as by configuring the reservoir randomization element 106 to at least partially maintain collimation while still imposing some level of randomization. One will appreciate, in view of the present disclosure, that a reservoir randomization element 106 can have different randomization characteristics for different use cases.

The light randomly distributed among the reservoir lasers 102 by the reservoir randomization element 106 can contribute to injection-locking of the reservoir lasers 102. For instance, a particular reservoir laser from the set of reservoir lasers 102 can receive light diffusely reflected by the reservoir randomization element 106 represented as Z=Σzᵢ, where zᵢ represents the 2-dimensional complex vector indicating electric field amplitudes of the two polarization modes (Jones vector) for light from each of the reservoir lasers 102 that is received by the particular reservoir laser. The light received by the particular reservoir laser can cause injection locking of the particular reservoir laser, which can be characterized as weak, strong, or moderate (e.g., exhibiting combined characteristics/components of weak and strong injection locking). Under weak injection locking, the particular reservoir laser can output light with a phase φ characterized by:

$$ϕ ( Z ) ∝ \frac{Z}{‖ Z ‖} .$$

Under strong injection locking, the particular reservoir laser can output light with a phase φ characterized by:

$$ϕ ( Z ) ∝ Z .$$

The coupling between any two of the reservoir lasers of the set of reservoir lasers 102 can be reciprocal. For instance, the coupling efficiency of one reservoir laser a and another reservoir laser b that are coupled via the reservoir randomization element 106 can be characterized as w_{ab}=w_{ba}, where w_{ab} represents the coupling coefficient from reservoir laser a to reservoir laser b and where w_{ba} represents the coupling coefficient from reservoir laser b to reservoir laser a.

This injection-locking of the reservoir lasers 102 (accomplished via the reservoir randomization element 106) can thus achieve coupling among the reservoir lasers 102 while still preserving the nonlinearity inherent in injection-locked lasers, enabling the reservoir lasers 102 to operate as nodes or neurons for a reservoir computer to perform machine learning or AI operations.

In addition to facilitating randomized interconnectedness among the reservoir lasers 102 (via injection locking), the reservoir randomization element 106 can act as an output interface to direct light output by the reservoir lasers 102 toward an output system. For instance, in addition to diffusely reflecting the light from the reservoir lasers 102, the reservoir randomization element 106 can be configured to partially diffusely transmit the light, permitting the light to pass through toward output componentry. Additional details related to an example output system for a reservoir computer as described herein will be provided hereinbelow with reference to FIG. 3.

FIG. 1 illustrates additional example components of the optical reservoir 100. For instance, the optical reservoir 100 shown in FIG. 1 includes a lens array 108 (e.g., a micro-lens array) that intervenes between the reservoir lasers 102 and the reservoir randomization element 106. The lens array 108 can be implemented to impart desired spatial coherence, beam divergence, and/or other characteristics on the light emitted by the reservoir lasers 102 for optical interaction with downstream components. For instance, the lens array 108 can cause the beams from the reservoir lasers 102 to diverge enough to facilitate even illumination of the Fourier plane of the reservoir lens 110 (described below).

FIG. 1 also illustrates the optical reservoir 100 as including a reservoir lens 110 that intervenes between the reservoir lasers 102 (and/or the lens array 108) and the reservoir randomization element 106. The reservoir lens 110 can Fourier transform and/or focus light propagating between the reservoir lasers 102 and the reservoir randomization element 106. In some implementations, the reservoir lens 110 is distanced from the reservoir randomization element 106 by about one focal length of the reservoir lens 110. Similarly, the reservoir lens 110 can be distanced from the reservoir lasers 102 (and/or the lens array 108) by about one focal length of the reservoir lens 110.

Example operation of the optical reservoir 100 can comprise forming an image via the reservoir lasers 102, Fourier-transforming the image via the reservoir lens 110, diffusely reflecting the Fourier-transformed image back toward the reservoir lasers 102 via the reservoir randomization element 106, causing injection-locking and random interconnection of the reservoir lasers 102.

Although FIG. 1 illustrates the optical reservoir 100 as having specific components and/or characteristics, variations are within the scope of the present disclosure. For instance, although the reservoir laser array 104 shown in FIG. 1 comprises a 5×5 array, a reservoir laser array of an optical reservoir as disclosed herein can include an array or matrix of any size and/or shape. The reservoir laser array 104 can comprise any suitable size (e.g., with diameters on the scale of micrometers, centimeters, etc.). Furthermore, reservoir lasers of an optical reservoir as disclosed herein need not be arranged in an array, and/or the reservoir randomization element can take on other forms. For instance, reservoir lasers can be positioned throughout a medium with light scattering/diffusion characteristics (which medium can act as the reservoir randomization element). One will appreciate that an optical reservoir as disclosed herein can include multiple sets/arrays of lasers and randomization elements that optically interact with one another. For instance, a second set of reservoir lasers can receive light from the reservoir randomization element 106 to become injection locked thereby, and the second set of reservoir lasers can direct light toward a second randomization element, etc.

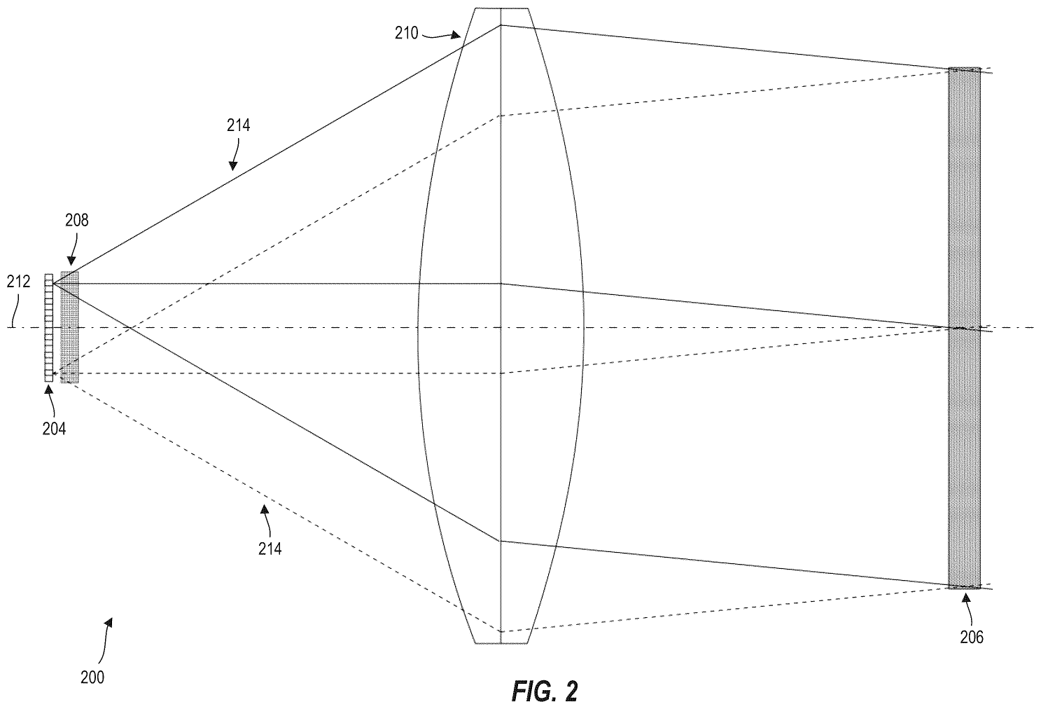

FIG. 2 illustrates a schematic diagram of an example optical reservoir 200 for a reservoir computing system. The optical reservoir 200 includes components similar to those described hereinabove for the optical reservoir 100 shown in FIG. 1. For instance, the optical reservoir 200 includes a reservoir laser array 204, a lens array 208, a reservoir lens 210, and a reservoir randomization element 206. FIG. 2 illustrates an example optic axis 212 (represented as a long-short dashed line) and lines 214 representing light propagation from different lasers of the reservoir laser array 204 throughout the various components (solid and dashed lines).

The example optical reservoir 200 shown in FIG. 2 can have various properties/characteristics. Illustrative, non-limiting example sets of properties/characteristics for an optical reservoir 200 are provided here:

### Example 1

Neural Network Properties: number of lasers in a row: N=100; number of lasers: N×N=10,000; number of connections Nc=(N×N)²=100 million connections (maximum independent variables or weights 0.5(N×N)²=50 million connections due to bidirectionality).

Lasers, Geometry, and Dimensions: laser output beam divergence half-angle: 30 degrees (micro-lens can be included if needed based on laser aperture); laser pitch on wafer: 30 μm; panel side length: 3.0 mm; panel area: 9 mm\hat{ }2/panel; laser injection-lock rate: 10 GHz; laser injection-lock time: tᵢₙⱼ=0.1 ns; optical round-trip length: 60 mm; optical round-trip time: tᵣₜ=0.2 ns; optical round-trip+activation/injection-locking time: tₜₒₜ=tᵢₙⱼ+tᵣₜ=0.3 ns.

Signal Properties: asynchronous operation; analog computation; signal format: complex or quaternions; connectivity bandwidth: Nc/tₜₒₜ=170 peta-Hz.

Power and Heat Dissipation: power consumption: 0.0125 W/laser; power consumption of panel: 125 W/panel; required heat dissipation: 14 W/mm\hat{ }2.

Reservoir/Focusing Lens: refractive index: n=1.7; lens curvatures: R1=−R2=21 mm; focal length: f=15 mm; full height: 21.2 mm; thickness: d=5.6 mm.

### Example 2

Neural Network Properties: number of lasers in a row: N=256; number of lasers: N×N=65,536; number of connections Nc=0.5(N×N)²=4294 million connections (maximum independent variables or weights 0.5(N×N)²=2147 million connections due to bidirectionality).

Lasers, Geometry, and Dimensions: laser output beam divergence half-angle: 30 degrees (micro-lens can be included if needed based on laser aperture); laser pitch on wafer: 30 μm; panel side length: 7.7 mm; panel area: 59 mm\hat{ }2/panel; laser injection-lock rate: 10 GHz; laser injection-lock time: tᵢₙⱼ=0.1 ns; optical round-trip length: 154 mm; optical round-trip time: tᵣₜ=0.5 ns; optical round-trip+activation/injection-locking time: tₜₒₜ=tᵢₙⱼ+tᵣₜ=0.6 ns.

Signal Properties: asynchronous operation; analog computation; signal format: complex or quaternions; connectivity bandwidth: Nc/tₜₒₜ=3500 peta-Hz.

Power and Heat Dissipation: power consumption: 0.0125 W/laser; power consumption of panel: 819 W/panel; required heat dissipation: 14 W/mm\hat{ }2.

Reservoir/Focusing Lens: refractive index: n=1.7; lens curvatures: R1=−R2=21 mm; focal length: f=15 mm; full height: 25.1 mm; thickness: d=5.6 mm.

FIG. 3 illustrates a conceptual representation of components of an example reservoir computing system 300, which includes the optical reservoir 100 described hereinabove with reference to FIG. 1 and an input system 310 (e.g., upstream of the optical reservoir 100) and an output system 350 (e.g., downstream of the optical reservoir 100).

The input system 310 of the reservoir computing system 300 is configured to generate an input signal and provide the input signal to the optical reservoir 100. In the example shown in FIG. 3, the input signal comprises input light that is directed toward the reservoir lasers 102 of the optical reservoir 100 and that contributes to injection locking of the reservoir lasers 102. For instance, FIG. 3 illustrates the input system 310 as including input lasers 312 (e.g., arranged to form an input laser array 314) that generate the light that forms the input signal that is provided to the optical reservoir 100. The input lasers 312 may be driven/pumped to generate light representative of input data (e.g., for training and/or inference purposes), such as by modulating the input data into the phase or polarization of the light generated by the input lasers 312.

The input system 310 shown in FIG. 3 further includes an input randomization element 316 that is positioned to receive the light generated by the input lasers 312 and randomly distribute it among the reservoir lasers 102 of the optical reservoir 100. As indicated above, the light from the input randomization element 316 may contribute to the injection locking of the reservoir lasers 102. The input randomization element 316 can be implemented as a diffusely transmissive screen that is adapted to diffusely transmit the light from the input lasers 312 toward the reservoir lasers 102. Similar to the reservoir randomization element 106, the input randomization element 316 can have constant and/or tailored randomization characteristics (e.g., to mitigate light loss). The input randomization element 316 can facilitate randomized connection between the input lasers 312 (acting as input nodes/neurons for the reservoir computing system 300) and the reservoir lasers 102 (acting as reservoir nodes/neurons for the reservoir computing system 300).

In the example shown in FIG. 3, the input laser array 314 includes a lesser quantity of lasers than the reservoir lasers 102 of the optical reservoir 100 (e.g., similar to conventional reservoir computers that often have fewer input neurons than reservoir neurons). Although FIG. 3 illustrates the input laser array 314 as including five input lasers 312, any quantity or arrangement of input lasers may be used. The input system 310 can include one or more input lenses that direct light generated by the input lasers 312 toward the optical reservoir 100. The input system 310 shown in FIG. 3 includes a lens array 318 (e.g., a microlens array) configured to shape the light from the input lasers 312 for propagation through an input lens 320 that transforms the light for diffuse transmission or randomization by the input randomization element 316. The input system 310 also includes an additional input lens 322 that intervenes between the input randomization element 316 and the reservoir lasers 102 of the optical reservoir 100 to focus the input light/signal from the input system 310 toward the reservoir lasers 102 of the optical reservoir 100. The input lenses 320 and 322 can be separated from neighboring components by their respective focal lengths.

FIG. 3 also illustrates the input system 310 as including a reference laser 324 with accompanying optics 326 that are arranged to direct light toward the input lasers 312. The reference laser 324 can act as a global reference laser for the input lasers 312 and can have a coherence that is higher than the coherence of the input lasers 312. The reference laser 324 can injection-lock the input lasers 312 and can increase the coherence of the input lasers 312 (due to being controlled by the higher-coherence reference laser 324).

The output system 350 can provide a means to observe or assess the state of polarization of the light output from the optical reservoir 100. The polarization of the light output from the optical reservoir 100 can provide a basis for determining an output signal of the reservoir computing system 300, which can be used for model training and/or inference purposes. In the example shown in FIG. 3, the output system 350 includes a spatial light modulator 352 configured to receive and selectively modulate light received from the optical reservoir 100 (e.g., from the reservoir randomization element 106). The spatial light modulator 352 can take on various forms, such as a liquid crystal array, electro-optic modulator, indium phosphate modulator, lithium niobate modulator, and/or others. The spatial light modulator 352 can further include or be proximate to a polarization filter (e.g., a linear polarizer), which can enable the intensity of the light transmitted through the spatial light modulator 352 to indicate or represent the relative polarization state of the various regions of light reaching the spatial light modulator 352 from the optical reservoir 100.

The spatial light modulator 352 can control/modulate the light from the optical reservoir 100 that reaches readout componentry of the output system 350. In the example shown in FIG. 3, the output system 350 includes photodiodes 354 (with accompanying optics 356) that can act as output nodes for the reservoir computing system 300. For instance, the photodiodes 354 can be configured to receive the light received from the spatial light modulator 352 and generate an output signal (e.g., an electrical signal indicating an output label, prediction, value, classification, state, control, etc.). Although FIG. 3 illustrates five photodiodes 354, any quantity or arrangement of photodiodes 354 may be used.

Control of the spatial light modulator 352 can be governed by weights that are trained or tuned via reservoir computing training methods or readout training techniques (e.g., readout training, ridge regression, least squares regression, gradient descent for readout weights, etc.). By way of illustrative example, input training data may be modulated/encoded into the light generated by the input lasers 312 and can propagate through the input system 310 and the optical reservoir 100 to reach the spatial light modulator 352 of the output system 350. The spatial light modulator 352 can be initially controlled with initialized weights (e.g., randomized weights), and the output signal generated by the photodiodes 354 can be used in conjunction with ground truth data to train/tune the weights for controlling the spatial light modulator 352 in subsequent iterations via regression-based techniques or any suitable training method. Such operations may be iterated using training and ground truth data until a stop condition is satisfied, thereby yielding at a set of trained weights for controlling the spatial light modulator 352 for validation and/or inference using novel input data.

FIG. 3 illustrates that the output system 350 can include one or more output lenses configured to direct light received from the optical reservoir 100 toward the photodiodes 354. For instance, FIG. 3 illustrates an output lens 358 that focuses the light from the optical reservoir 100 on the spatial light modulator 352. The output system 350 as shown in FIG. 3 also includes an additional output lens 360 that directs the light from the spatial light modulator 352 toward the photodiodes 354. The output lenses 358 and 360 can be separated from neighboring components by their respective focal lengths.

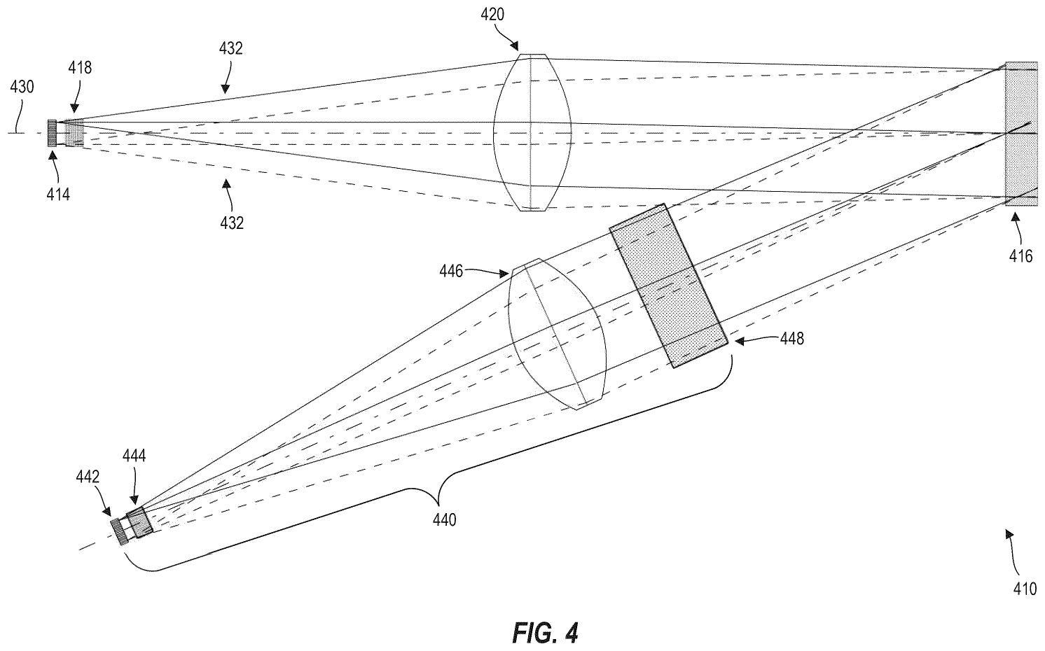

One will appreciate that the disclosed subject matter includes variants of the components and/or configurations of the example reservoir computing system 300 discussed with reference to FIG. 3. For instance, an input system of a reservoir computing system can omit a global reference laser. As another example, the input system of a reservoir computing system can include a biasing system. FIG. 4 illustrates a schematic diagram of an example input system 410 for a reservoir computing system. The input system 410 includes components similar to those described hereinabove for the input system 310 shown in FIG. 3. For instance, the input system 410 includes an input laser array 414, a lens array 418, an input lens 420, and an input randomization element 416. FIG. 4 illustrates an example optic axis 430 (represented as a long-short dashed line) and lines 432 representing light propagation from different lasers of the input laser array 414 throughout the various components (solid and dashed lines). The input system 410 shown in FIG. 4 also includes a biasing system 440 for directing bias light toward the input randomization element 416. The biasing system 440 includes one or more bias lasers 442 (with one or more accompanying microlenses 444), a bias lens 446, and a bias randomization element 448 (e.g., a diffusely transmissive screen). Although not shown in FIG. 4, an additional bias lens may intervene between the bias randomization element 448 and the input randomization element 416.

In some instances, a reservoir computer as disclosed herein can omit an optics-based input system as shown in the example of FIG. 3 and can instead rely on pumping of the reservoir lasers 102 of the optical reservoir 100 based on input data, which pumping can implement controlled randomization.

The laser, photodiode, lens, and/or randomization element configurations given in the example reservoir computing system 300 shown in FIG. 3 are illustrative only and can be varied in other implementations. For instance, one or more of the lens arrays, input lenses, reservoir lenses, and/or output lenses may be omitted in some embodiments.

### Example Embodiments

Embodiments disclosed herein can include those in the following numbered clauses:

Clause 1. A reservoir computing system, comprising: an input system configured to generate an input signal; an optical reservoir configured to receive the input signal from the input system, the optical reservoir comprising: a plurality of reservoir lasers, wherein each reservoir laser of the plurality of reservoir lasers is configured for injection-locked operation; and a reservoir randomization element configured to randomly distribute light output by the plurality of reservoir lasers among the plurality of reservoir lasers to contribute to injection locking of the plurality of reservoir lasers; and an output system configured to generate an output signal based on light received from the optical reservoir.

Clause 2. The reservoir computing system of clause 1, wherein each of the plurality of reservoir lasers is configured to emit light with substantially the same wavelength.

Clause 3. The reservoir computing system of clause 1, wherein each of the plurality of reservoir lasers is arranged to form a reservoir laser array.

Clause 4. The reservoir computing system of clause 3, wherein the reservoir randomization element comprises a randomly diffuse screen arranged to receive light output by the reservoir laser array, wherein the randomly diffuse screen is configured to (i) diffusely reflect incoming light toward the reservoir laser array and (ii) diffusely transmit incoming light toward the output system.

Clause 5. The reservoir computing system of clause 4, wherein the optical reservoir further comprises a reservoir lens intervening between the reservoir laser array and the randomly diffuse screen.

Clause 6. The reservoir computing system of clause 5, wherein the reservoir lens is separated from the reservoir laser array and the randomly diffuse screen by about one focal length of the reservoir lens.

Clause 7. The reservoir computing system of clause 4, wherein the optical reservoir further comprises a reservoir lens array intervening between the reservoir laser array and the randomly diffuse screen.

Clause 8. The reservoir computing system of clause 1, wherein the input system comprises: an input laser array comprising a plurality of input lasers arranged in an array; and an input randomization element arranged to randomly distribute light output by the input laser array among the plurality of reservoir lasers to contribute to injection locking of the plurality of reservoir lasers.

Clause 9. The reservoir computing system of clause 8, wherein the plurality of input lasers comprises a lesser quantity of lasers relative to the plurality of reservoir lasers.

Clause 10. The reservoir computing system of clause 8, wherein the input system further comprises one or more reference lasers configured to direct light toward the input laser array to contribute to injection locking of the plurality of input lasers.

Clause 11. The reservoir computing system of clause 8, wherein the input system further comprises one or more input lenses configured to direct light output by the input laser array toward the optical reservoir.

Clause 12. The reservoir computing system of clause 11, wherein the one or more input lenses comprise: a first input lens intervening between the input laser array and the input randomization element; and a second input lens intervening between the input randomization element and the optical reservoir.

Clause 13. The reservoir computing system of clause 8, wherein the input system further comprises a biasing system configured to direct bias light toward the input randomization element.

Clause 14. The reservoir computing system of clause 1, wherein the output system comprises: a spatial light modulator configured to selectively modulate light received from the optical reservoir; and a plurality of photodiodes configured to generate an output signal for the reservoir computing system based on light received from the spatial light modulator.

Clause 15. The reservoir computing system of clause 14, wherein the output system further comprises one or more output lenses configured to direct light received from the optical reservoir toward the plurality of photodiodes.

Clause 16. The reservoir computing system of clause 15, wherein the one or more output lenses comprise: a first output lens intervening between the reservoir randomization element and the spatial light modulator; and a second output lens intervening between the spatial light modulator and the plurality of photodiodes.

Clause 17. An optical reservoir for a reservoir computing system, the optical reservoir comprising: a reservoir laser array comprising a plurality of reservoir lasers arranged in an array, wherein each reservoir laser of the reservoir laser array is configured for injection-locked operation; a randomly diffuse screen arranged to receive light output by the reservoir laser array, wherein the randomly diffuse screen is configured to (i) diffusely reflect incoming light toward the reservoir laser array to contribute to injection locking of the plurality of reservoir lasers and (ii) diffusely transmit incoming light toward an output system; and a reservoir lens intervening between the reservoir laser array and the randomly diffuse screen.

Clause 18. The optical reservoir of clause 17, wherein the reservoir laser array is configured to receive light from an input system that contributes to injection locking of the plurality of reservoir lasers.

Clause 19. An optical reservoir for a reservoir computing system, the optical reservoir comprising: a plurality of reservoir lasers, wherein each reservoir laser of the plurality of reservoir lasers is configured for injection-locked operation; a reservoir randomization element configured to randomly distribute light output by the plurality of reservoir lasers among the plurality of reservoir lasers to contribute to injection locking of the plurality of reservoir lasers; and an output interface configured to direct light output by the plurality of reservoir lasers toward an output system.

Clause 20. The optical reservoir of clause 19, wherein the plurality of reservoir lasers is configured to receive light from an input system that contributes to injection locking of the plurality of reservoir lasers.

### Additional Details Related to the Disclosed Embodiments

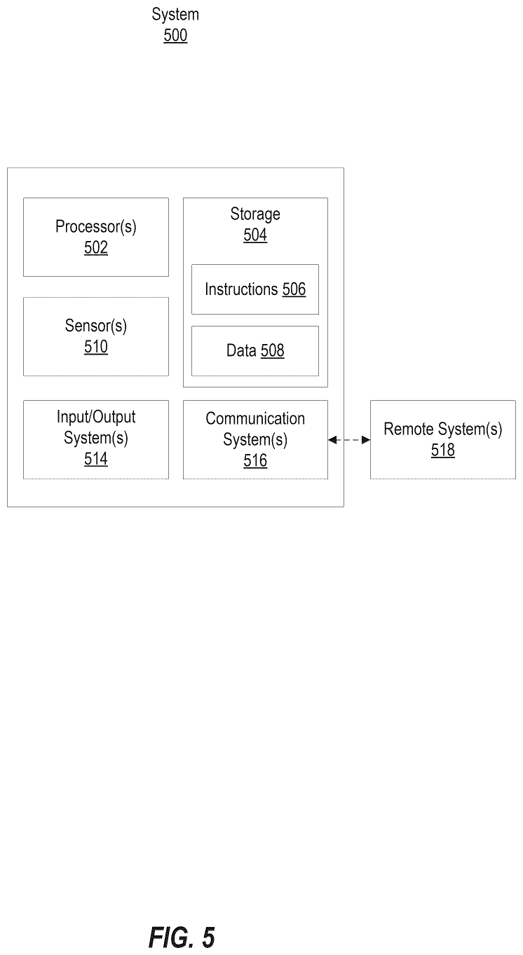

FIG. 5 illustrates various example components of a system 500 that may be used when implementing one or more disclosed embodiments (e.g., to pump or modulate the input lasers 312 to encode input data or an input signal, to receive and/or process the output signal acquired via the photodiodes 354, to control the spatial light modulator 352, etc.). For example, FIG. 5 illustrates that a system 500 may include processor(s) 502, storage 504, sensor(s) 510, input/output system(s) 514 (I/O system(s) 514), and communication system(s) 516. Although FIG. 5 illustrates a system 500 as including particular components, one will appreciate, in view of the present disclosure, that a system 500 may comprise any number of additional or alternative components.

The processor(s) 502 may comprise one or more sets of electronic circuitries that include any number of logic units, registers, and/or control units to facilitate the execution of computer-readable instructions (e.g., instructions that form a computer program). Processor(s) 502 may take on various forms, such as, by way of non-limiting example, Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

Computer-readable instructions may be stored within storage 504. The storage 504 may comprise physical system memory and may be volatile, non-volatile, or some combination thereof. Furthermore, storage 504 may comprise local storage, remote storage (e.g., accessible via communication system(s) 516 or otherwise), or some combination thereof. Additional details related to processors (e.g., processor(s) 502) and computer storage media (e.g., storage 504) will be provided hereinafter.

In some implementations, the processor(s) 502 may comprise or be configurable to execute any combination of software and/or hardware components that are operable to facilitate processing using machine learning models or other artificial intelligence-based structures/architectures. For example, processor(s) 502 may comprise and/or utilize hardware components or computer-executable instructions operable to carry out function blocks and/or processing layers configured in the form of, by way of non-limiting example, fully connected layers, convolutional layers, pooling layers, recurrent layers, embedding layers, dropout layers, normalization layers, attention layers, transformer layers, flatten layers, and/or others without limitation.

As will be described in more detail, the processor(s) 502 may be configured to execute instructions 506 stored within storage 504 to perform certain actions. The actions may rely at least in part on data 508 stored on storage 504 in a volatile or non-volatile manner.

In some instances, the actions may rely at least in part on communication system(s) 516 for receiving data from remote system(s) 518, which may include, for example, separate systems or computing devices, sensors, and/or others. The communications system(s) 516 may comprise any combination of software or hardware components that are operable to facilitate communication between on-system components/devices and/or with off-system components/devices. For example, the communications system(s) 516 may comprise ports, buses, or other physical connection apparatuses for communicating with other devices/components. Additionally, or alternatively, the communications system(s) 516 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 5 illustrates that a system 500 may comprise or be in communication with sensor(s) 510. Sensor(s) 510 may comprise any device for capturing or measuring data representative of perceivable or detectable phenomena. By way of non-limiting example, the sensor(s) 510 may comprise one or more radar sensors, image sensors, microphones, thermometers, barometers, magnetometers, accelerometers, gyroscopes, and/or others.

Furthermore, FIG. 5 illustrates that a system 500 may comprise or be in communication with I/O system(s) 514. I/O system(s) 514 may include any type of input or output device such as, byway of non-limiting example, a touch screen, a mouse, a keyboard, a controller, and/or others, without limitation. For example, the I/O system(s) 514 may include a display system that may comprise any number of display panels, optics, laser scanning display assemblies, and/or other components.

At least some components of the system 500 may comprise or utilize various types of devices, such as servers, workstations, clusters, pods, edge devices, mobile electronic devices (e.g., smartphones), personal computing devices (e.g., a laptops), wearable devices (e.g., smartwatches, HMDs, etc.), vehicles (e.g., aerial vehicles, autonomous vehicles, etc.), and/or other devices. A system 500 may take on other forms in accordance with the present disclosure.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope

I claim:

1. A reservoir computing system, comprising:
an input system configured to generate an input signal;
an optical reservoir configured to receive the input signal from the input system, the optical reservoir comprising:
a plurality of reservoir lasers, wherein each reservoir laser of the plurality of reservoir lasers is configured for injection-locked operation; and
a reservoir randomization element configured to randomly distribute light output by the plurality of reservoir lasers among the plurality of reservoir lasers to contribute to injection locking of the plurality of reservoir lasers; and
an output system configured to generate an output signal based on light received from the optical reservoir.

2. The reservoir computing system of claim 1, wherein each of the plurality of reservoir lasers is configured to emit light with substantially the same wavelength.

3. The reservoir computing system of claim 1, wherein each of the plurality of reservoir lasers is arranged to form a reservoir laser array.

4. The reservoir computing system of claim 3, wherein the reservoir randomization element comprises a randomly diffuse screen arranged to receive light output by the reservoir laser array, wherein the randomly diffuse screen is configured to (i) diffusely reflect incoming light toward the reservoir laser array and (ii) diffusely transmit incoming light toward the output system.

5. The reservoir computing system of claim 4, wherein the optical reservoir further comprises a reservoir lens intervening between the reservoir laser array and the randomly diffuse screen.

6. The reservoir computing system of claim 5, wherein the reservoir lens is separated from the reservoir laser array and the randomly diffuse screen by about one focal length of the reservoir lens.

7. The reservoir computing system of claim 4, wherein the optical reservoir further comprises a reservoir lens array intervening between the reservoir laser array and the randomly diffuse screen.

8. The reservoir computing system of claim 1, wherein the input system comprises:
an input laser array comprising a plurality of input lasers arranged in an array; and
an input randomization element arranged to randomly distribute light output by the input laser array among the plurality of reservoir lasers to contribute to injection locking of the plurality of reservoir lasers.

9. The reservoir computing system of claim 8, wherein the plurality of input lasers comprises a lesser quantity of lasers relative to the plurality of reservoir lasers.

10. The reservoir computing system of claim 8, wherein the input system further comprises one or more reference lasers configured to direct light toward the input laser array to contribute to injection locking of the plurality of input lasers.

11. The reservoir computing system of claim 8, wherein the input system further comprises one or more input lenses configured to direct light output by the input laser array toward the optical reservoir.

12. The reservoir computing system of claim 11, wherein the one or more input lenses comprise:
a first input lens intervening between the input laser array and the input randomization element; and
a second input lens intervening between the input randomization element and the optical reservoir.

13. The reservoir computing system of claim 8, wherein the input system further comprises a biasing system configured to direct bias light toward the input randomization element.

14. The reservoir computing system of claim 1, wherein the output system comprises:
a spatial light modulator configured to selectively modulate light received from the optical reservoir; and
a plurality of photodiodes configured to generate an output signal for the reservoir computing system based on light received from the spatial light modulator.

15. The reservoir computing system of claim 14, wherein the output system further comprises one or more output lenses configured to direct light received from the optical reservoir toward the plurality of photodiodes.

16. The reservoir computing system of claim 15, wherein the one or more output lenses comprise:
a first output lens intervening between the reservoir randomization element and the spatial light modulator; and
a second output lens intervening between the spatial light modulator and the plurality of photodiodes.

17. An optical reservoir for a reservoir computing system, the optical reservoir comprising:
a reservoir laser array comprising a plurality of reservoir lasers arranged in an array, wherein each reservoir laser of the reservoir laser array is configured for injection-locked operation;
a randomly diffuse screen arranged to receive light output by the reservoir laser array, wherein the randomly diffuse screen is configured to (i) diffusely reflect incoming light toward the reservoir laser array to contribute to injection locking of the plurality of reservoir lasers and (ii) diffusely transmit incoming light toward an output system; and
a reservoir lens intervening between the reservoir laser array and the randomly diffuse screen.

18. The optical reservoir of claim 17, wherein the reservoir laser array is configured to receive light from an input system that contributes to injection locking of the plurality of reservoir lasers.

19. An optical reservoir for a reservoir computing system, the optical reservoir comprising:
a plurality of reservoir lasers, wherein each reservoir laser of the plurality of reservoir lasers is configured for injection-locked operation;
a reservoir randomization element configured to randomly distribute light output by the plurality of reservoir lasers among the plurality of reservoir lasers to contribute to injection locking of the plurality of reservoir lasers; and
an output interface configured to direct light output by the plurality of reservoir lasers toward an output system.

20. The optical reservoir of claim 19, wherein the plurality of reservoir lasers is configured to receive light from an input system that contributes to injection locking of the plurality of reservoir lasers.
